(19) United States
(12) Patent Application Publication
(10) Pub. No.: US 2018/0125112 A1
(43) Pub. Date: May 10, 2018

(54) COMPOSITION WITH ANTI-SNORTING PROPERTIES AND METHOD THEREOF

(71) Applicant: NAINAR AMALAN PRADEEP JEYAPRAKASH, CHENNAI (IN)

(72) Inventor: NAINAR AMALAN PRADEEP JEYAPRAKASH, CHENNAI (IN)

(21) Appl. No.: 15/786,752

(22) Filed: Oct. 18, 2017

Related U.S. Application Data
(60) Provisional application No. 62/411,747, filed on Oct. 24, 2016.

(51) Int. Cl. A23P 10/30; B01J 13/18; B01J 13/04; B01J 13/20; A23L 17/60; C12G 3/04; A23L 27/40; A23L 29/262; A23L 29/30

(52) U.S. Cl. CPC A23P 10/30; B01J 13/18; B01J 13/043; B01J 13/20; A23V 2002/00; C12G 3/04; A23L 27/40; A23L 29/262; A23L 29/30; A23L 17/60

(57) ABSTRACT

A composition with anti-snorting properties comprising a liquid based formulation, a marine seaweed extract, a plurality of salts, cellulose, carbohydrate and a plurality of additives.

### CROSS-REFERENCE TO RELATED APPLICATION

This application claims the benefit of U.S. Provisional Application No. 62/411,747, filed on Oct. 24, 2016.

### FIELD OF THE INVENTION

The present disclosure, generally relates to encapsulation of liquids. More specifically, the present invention is a composition with anti-snorting properties and method thereof.

### BACKGROUND OF THE INVENTION

Alcohol is formed when yeast ferments (breaks down without oxygen) the sugars in different food. For example, wine is made from the sugar in grapes, beer from the sugar in malted barley (a type of grain), cider from the sugar in apples and vodka from the sugar in potatoes, beets or other plants.

In moving trends and lifestyle, drinking is common among folks. Alcohol nowadays is available in numerous forms, one of which is powdered alcohol. Powdered alcohol has been creating a lot of buzz lately in the food industry and in states around the country. In addition, this powdered alcohol is also used as a flavoring agent in several foods, beverages and many alcohol infused products such as alcohol whipped cream etc.

US20020136816 A1 discloses a dry composition capable of generating alcoholic beer in the presence of water. The composition is alcohol based in the form of powder or tablet, which is used for producing a carbonated beer beverage.

U.S. Pat. No. 5,019,414 A discloses a pipeable-gelled food and ethyl alcohol beverages. An edible thickened or gelled composition of a liquid form of food product comprising alcohol is described in jelly food form.

U.S. Pat. No. 3,821,433 describes preparation of an alcohol-containing powder. A method is provided for preparation of a flowable, dry-to-the touch, alcohol-containing powder that is edible ethanol containing carbohydrate powders.

However, this powdered form of alcohol generates a new problem of abuse/snorting. As the many of the alcohol consumers become addicted to the liquor and start finding new ways out to consume alcohol for faster and strong hallucinations. For this purpose, they misuse the powdered form of the alcohol and start snorting them thereby leading to the severe medical conditions such as significantly slowed, shallow, or irregular breathing, profound drowsiness, severe nausea, copious vomiting, tiny, constricted pupils, cold and clammy skin, blurry vision, muscle weakness, loss of consciousness and fainting.

Young adults are snorting powdered form of alcohol. It is the latest vogue in the world of intoxication and it is hazardous. Moreover, snorting alcohol can also lead to addiction or enslavement much faster than drinking alcohol because the effects are much more prompt and intense, without having to go through the stomach or the liver for filtration and detoxification; it goes straight in through the sinuses and is quite an effective delivery system.

However, there remains a need in the art for preparing a composition of encapsulated liquid based formulations. The methods for preparing encapsulated micro-spherules of the liquid based formulations eliminates the risk rate of abuse/snorting. Further, the method is easy and is cost efficient.

Any discussion of the background art throughout the specification should in no way be considered as an admission that such background art is prior art nor that such background art is widely known or forms part of the common general knowledge.

### SUMMARY OF THE INVENTION

There is provided a composition with anti-snorting properties comprising: a liquid based formulation, a marine seaweed extract, a plurality of salts and a plurality of additives.

In accordance with an embodiment of the present invention, the liquid based formulation is selected from the group consisting of, but not limited to, ethanol, edible spirits, juices, extracts and medicines containing water or alcohol.

In accordance with an embodiment of the present invention, the edible spirits are selected from the group consisting of, but not limited to, brandy, fruit brandies, ciders, fermented teas, wines, beers, horilkas, liqueurs, grain spirits, pisco, rice drinks, tequila, vodka, gin, rum, whisky, eau de vie (fruit brandy or schnapps), baijiu, soju, aguardiente, pálinka, cachaça, singani, borovička, slivovitz, fenny, arrack, toddy, sake, fermented spirits, Indian Made Foreign Liquor (IMFL) and ethanol.

In accordance with an embodiment of the present invention, the marine seaweed extract is selected from the group consisting of, but not limited to, agar, alginates, gelatin and carrageenan.

In accordance with an embodiment of the present invention, the plurality of salts are selected from the group comprising of, but not limited to, citrate, phosphate, chlorate, sulphate or acetate salts of potassium, sodium and calcium.

In accordance with an embodiment of the present invention, further a plurality of additives are selected from the group consisting of, but not limited to, sugars, carbonates, preservatives, oleoresins, flavors, emulsifiers, aromatic materials, processed grains, fruits, juices, dry fruits, nuts, spices, nutrients, water soluble carbohydrates and combinations thereof.

In accordance with an embodiment of the present invention, the water-soluble carbohydrates are selected from the group consisting of, but not limited to, maltodextrin and cellulose.

In accordance with an embodiment of the present invention, the cellulose are selected from the group consisting of, but not limited to, ethylcellulose (EC), methylcellulose (MC), hypromellose (INN), hydroxypropyl cellulose (HPC), ethyl-methylcellulose (EMC) and soluble soybean polysaccharide (SSPS).

In accordance with an embodiment of the present invention, the sugars are selected from the group consisting of, but not limited to, monosaccharaides, disaccharides and natural and artificial sugar substitutes.

In accordance with an embodiment of the present invention, the monosaccharaides are selected from the group consisting of, but not limited to, fructose, galactose and glucose.

In accordance with an embodiment of the present invention, the disaccharides are selected from the group consisting of, but not limited to, lactose, maltose and sucrose.

In accordance with an embodiment of the present invention, the carbonates are selected from the group consisting of, but not limited to, carbonate and bicarbonate salts.

In accordance with an embodiment of the present invention, the nutrients are selected from the group consisting of, but not limited to, isotonic rehydration salts, electrolytes, antioxidants, minerals, vitamins and fiber.

In accordance with an embodiment of the present invention, the oleoresins are selected from the group consisting of, but not limited to, pepper, chili and ginger.

In accordance with an embodiment of the present invention, the encapsulated micro-spherules are processed in different forms, selected from the group consisting of, but not limited to, free flowing powder, solid lumps, semi-solid lumps, granules, cubes, pellets, tablets, bars, cakes and balls.

There is provided a method for the entrapment of liquid based formulations, comprising the steps of polymerizing a liquid based formulation by spherification using a marine seaweed extract and a plurality of salts, cellulose and carbohydrate to form spherules or beads or clumps, drying the spherules or beads, pulverizing the spherules to form micro-spherules, micro-encapsulating the micro-spherules and adding a plurality of additives to the micro-encapsulated spherules.

In accordance with an embodiment of the present invention, the liquid based formulation is selected from the group consisting of, but not limited to, edible spirits, juices, extracts and medicines containing water or alcohol.

In accordance with an embodiment of the present invention, the edible spirits are selected from the group consisting of, but not limited to, brandy, fruit brandies, ciders, fermented teas, wines, beers, horilkas, liqueurs, grain spirits, pisco, rice drinks, tequila, vodka, gin, rum, whisky, eau de vie (fruit brandy or schnapps), baijiu, soju, aguardiente, pálinka, cachaça, singani, borovička, slivovitz, fenny, arrack, toddy, sake, fermented spirits, Indian Made Foreign Liquor (IMFL) and ethanol.

In accordance with an embodiment of the present invention, the marine seaweed extract is selected from the group consisting of, but not limited to, agar, alginates, gelatin and carrageenan.

In accordance with an embodiment of the present invention, the plurality of salts are selected from the group comprising of, but not limited to, citrate, phosphate, chlorate, sulphate or acetate salts of potassium, sodium and calcium.

In accordance with an embodiment of the present invention, further a plurality of additives are selected from the group consisting of, but not limited to, sugars, carbonates, preservatives, oleoresins, flavors, emulsifiers, aromatic materials, processed grains, fruits, juices, dry fruits, nuts, spices, nutrients, water soluble carbohydrates and combinations thereof.

In accordance with an embodiment of the present invention, the water-soluble carbohydrates are selected from the group consisting of, but not limited to, maltodextrin and cellulose.

In accordance with an embodiment of the present invention, the cellulose are selected from the group consisting of, but not limited to, ethylcellulose (EC), methylcellulose (MC), hypromellose (INN), hydroxypropyl cellulose (HPC), ethyl-methylcellulose (EMC) and soluble soybean polysaccharide (SSPS).

In accordance with an embodiment of the present invention, the sugars are selected from the group consisting of, but not limited to, monosaccharaides, disaccharides and natural and artificial sugar substitutes.

In accordance with an embodiment of the present invention, the monosaccharaides are selected from the group consisting of, but not limited to, fructose, galactose and glucose.

In accordance with an embodiment of the present invention, the disaccharides are selected from the group consisting of, but not limited to, lactose, maltose and sucrose.

In accordance with an embodiment of the present invention, the carbonates are selected from the group consisting of, but not limited to, carbonate and bicarbonate salts.

In accordance with an embodiment of the present invention, the nutrients are selected from the group consisting of, but not limited to, isotonic rehydration salts, electrolytes, antioxidants, minerals, vitamins and fiber.

In accordance with an embodiment of the present invention, the oleoresins are selected from the group consisting of, but not limited to, pepper, chili and ginger.

### BRIEF DESCRIPTION OF THE DRAWINGS

So that the manner in which the above recited features of the present disclosure can be understood in detail, a more particular description of the disclosure, briefly summarized above, may have been referred by embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

These and other features, benefits, and advantages of the present disclosure will become apparent by reference to the following text figure, with like reference numbers referring to like structures across the views, wherein:

FIG. 1 is a flowchart illustrating a simplified method of entrapping liquid based formulations, in accordance with an embodiment of the present invention;

FIG. 2 illustrates a simplified sectional view of a bead or clump containing a mixture, in accordance with an embodiment of the present invention;

FIG. 3 illustrates a simplified sectional view of a micro spherule containing the mixture, in accordance with another embodiment of the present invention;

FIG. 4 illustrates a simplified sectional view of a micro encapsulated micro spherule containing the mixture, in accordance with another embodiment of the present invention; and

FIG. 5 is a schematic illustration of spray drying process for microencapsulation, in accordance with another embodiment of the present invention.

### DETAILED DESCRIPTION OF THE EMBODIMENTS

Detailed embodiments of the present disclosure are described herein; however, it is to be understood that disclosed embodiments are merely exemplary of the present disclosure, which may be embodied in various alternative forms. Specific process details disclosed herein are not to be interpreted as limiting, but merely as a representative basis for teaching one skilled in the art to variously employ the present disclosure in any appropriate process.

The terms used herein are for the purpose of describing exemplary embodiments only and are not intended to be limiting. As used herein, the singular forms “a,” “an,” and “the” are intended to include the plural forms as well, unless the context clearly indicates otherwise. It will be further understood that the terms “comprises” or “comprising,” when used in this specification, do not preclude the presence or addition of one or more components, steps, operations, and/or elements other than a mentioned component, step, operation, and/or element.

The embodiments of the present disclosure will now be described more fully hereinafter with reference to the accompanying drawings, which form a part hereof, and which show, by way of illustration, specific example embodiments. The following detailed description is not intended to be taken in a limiting sense.

The terms and descriptions used herein are set forth by way of illustration only and are not meant as limitations. Examples and limitations disclosed herein are intended to be not limiting in any manner, and modifications may be made without departing from the spirit of the present disclosure. Those skilled in the art will recognize that many variations are possible within the spirit and scope of the disclosure, and their equivalents, in which all terms are to be understood in their broadest possible sense unless otherwise indicated.

Alcohol consumption is very prevalent among the people of almost all the countries. Every human behavior has certain motivation behind it, people has interesting explanations for alcohol consumption. For some, it's a way of relieving stress, some drink because people around them are drinking, some tend to drink to have fun and younger crowd have the reason of curiosity. Several modifications in the forms and formulations of alcohol have been done to, for using alcohol for several other purposes as well. One such modification is transformation of liquid alcohol into powdered form or solid form. These solid or powdered forms of the alcohol are used in many food and beverage modification industries.

Nevertheless, these modifications also promote abuse/snorting among the population. Misuse of the powdered alcohol for getting instant alcoholic effect creates certain health disasters. Consequently, the encapsulation of the alcohol in solid, semi-solid forms eliminates the problem of abuse/snorting. The method used for encapsulation encourages the use of liquid based formulations such as edible spirits, fruit juices and medicine to be formulated into safe and easy to consume form with safety measures to avoid snorting.

In accordance with the embodiment of the present invention, a composition with anti-snorting properties comprises a liquid based formulation, a plurality of salts, a marine based seaweed extract and a plurality of additives.

In accordance with the embodiment of the present invention, the plurality of additives is easily digestible and facilitates sustainable, delayed and modified release of the liquid based formulations. The liquid based formulations are delivered with a certain delay after their administration. Sustained release provides delivery of liquid based formulations at a predetermined rate in order to maintain a constant drug concentration for a specific period of time. Extended-release dosage consists of sustained-release (SR) and controlled-release (CR). SR maintains drug release over a sustained period but not at a constant rate. CR maintains drug release over a sustained period at a nearly constant rate. TR maintains drug release on a particular target where the effect is required.

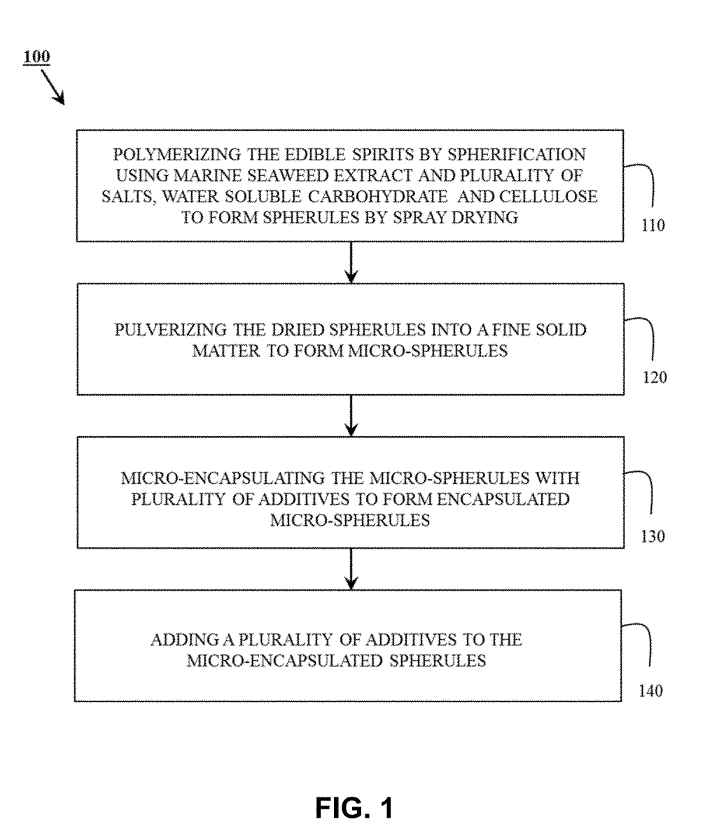

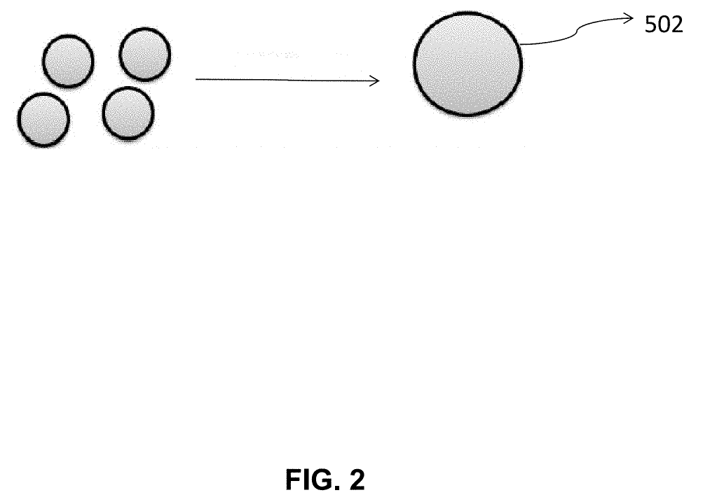

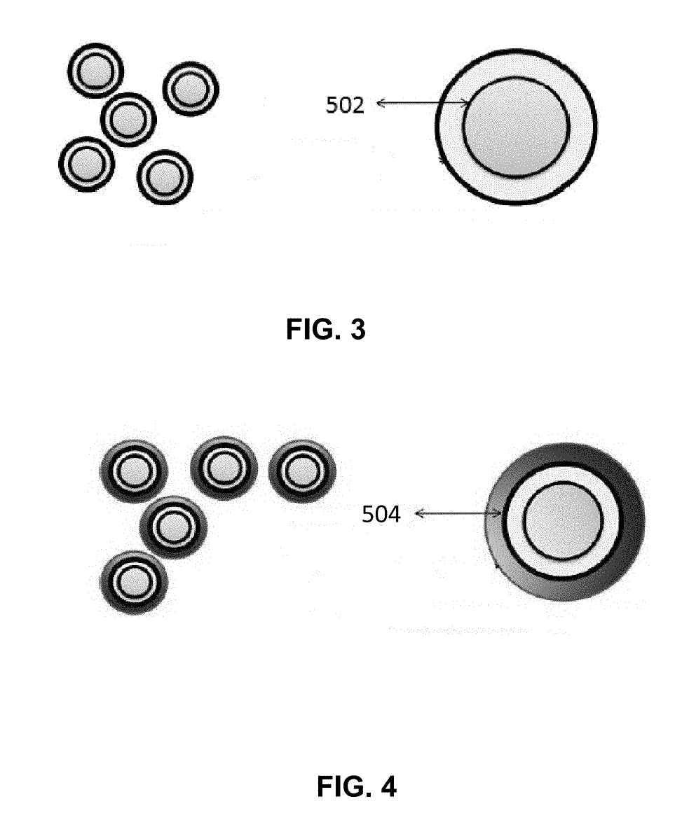

FIG. 1 is a flowchart illustrating a method (100) of entrapping a liquid based formulation to which the various embodiments described herein may be implemented. As shown in FIG. 1, the method begins at step 110 where the liquid based formulation is polymerized using marine seaweed extract, plurality of salts and cellulose.

In accordance with an embodiment of the present invention, polymerization can be explained as the practice of connecting together enormous small molecules to make a smaller number of very large molecules. Further, the spherification is the shaping of any liquid into spheres or beads or clumps preferably using sodium alginate and either calcium chloride or calcium glucate lactate and added cellulose. In the polymerization the calcium “salt” essentially helps connecting (crosslink) the alginate chains and making a gel like material that holds in the alcohol mixed fruit juice and other materials leading to the formation of beads (502), strings or spherules or clumps.

In accordance with an embodiment of the present invention, the plurality of salts are selected from the group comprising of, but not limited to, citrate, phosphate, chlorate, sulphate or acetate salts of potassium, sodium and calcium. Some materials like lipids and polymers, such as alginate, may be used as a mixture to trap the material of interest inside.

In accordance with an embodiment of the present invention, marine seaweed extract is selected from the group comprising of, but not limited to, agar, alginates or carrageenan. Alginate/carrageenan is a natural polymer that is derived from the cell walls of sea weeds and has a sticky, slimy, and gel like texture when mixed with water. Alginate/carrageenan is also added to act as a thickening agent.

In accordance with an embodiment of the present invention, gelatin (non-vegetarian) may also be used, in the composition to overcome the restriction of maintaining the vegetarian aspect of the substance.

In accordance with an embodiment of the present invention, alcohol selected from the group comprising of, but not limited to, ethanol/ethyl alcohol and other edible spirits like brandy, fruit brandies, ciders, fermented teas, wines, beers, horilkas, liqueurs, grain spirits, pisco, rice drinks, tequila, vodka, gin, rum, whisky, eau de vie (fruit brandy or schnapps), baijiu, soju, aguardiente, pálinka, cachaça, singani, borovička, slivovitz, country liquors (e.g. fenny, arrack, toddy, sake), other fermented or distilled spirits, etc.

In accordance with an embodiment of the present invention, marine seaweed extract, liquid based formulation, Hydroxypropyl Methyl Cellulose (HPMC) and maltodextrin either in form of drops or streams of these mixtures is added to a solution containing salts with ions. Further, this process results in the formation of clumps or beads (502), trapping the alcohol, fruit juice or the medicine extract and creating a relatively stable spherules or clumps or beads. The dried clumps or beads are pulverized into “micro” spheres.

In accordance with an embodiment of the present invention, the step (110) is explained as Spherification with alginate where the materials used are sodium alginate powder, water, calcium lactate (balls or powder), alcohol, fruit juice etc. Further, the following may be added if a dry powder of the substance is required: Hydroxypropyl Methyl Cellulose (HPMC) dissolve in water and in solvents, such as, ethanol/water in suitable proportion or/and Maltodextrin. Calcium ions help crosslink individual alginate polymer chains when the respective solutions come into contact. Positively charged Calcium (Ca2+) ions interact with negatively charged carboxylate (R—CO2—) groups from two separate alginate chains, holding them together. When many carboxylate groups from many different alginate chains interact, stable spherules or beads or clumps are formed.

In accordance with an embodiment of the present invention, the stable spherules or beads or clumps then produced are rapidly dried to remove any liquid present. Further, a method called spray drying was selected for encapsulation. Mixture of carbohydrate, seaweed extract, gelatin and micro spherules (504) with water, is dried into powder by spray drying in short time. After spraying, the mixture becomes many micro-sized drops. By the heat, carbohydrate for example hydrous dextrin and seaweed extract, gelatin outside of each ball forms a film. Further, after being sprayed, encapsulation for each drop is completed within about 0.1 second from the very beginning of the process. There is no time for the internal convection in each drop or capsule to occur.

At step 120, pulverizing the dried spherules or beads or clumps to form micro-spherules. The mass obtained is crushed, pulverized and shifted through mesh, forming the micro spherules (504). Further, pulverization is the act of grinding the solid into powder to obtain uniform size micro-spherules. Once the film gets dry, the ball becomes a microcapsule containing liquor micro spherules (504) and dextrin.

At step 130, micro-encapsulating the micro-spherules to form a dry powder using micro-encapsulation. Mixture of dextrin, seaweed extract, gelatin and liquor micro spherules with water are dried into powder by spray drying in short time. After spraying, the mixture gets converted into numerous micro-sized drops and with the help of heat, hydrous dextrin, seaweed extract or gelatin forms a thin film around each micro-sized drops. Once the film gets dry, the ball becomes a microcapsule containing composition micro spherules and dextrin. Further, micro-encapsulation is a procedure where tiny particles or droplets are surrounded by a coating to give small capsules, of many useful properties. Subsequently, it is used to incorporate food ingredients, enzymes, cells or other materials on a micro metric scale. Most microcapsules have pores with diameters between a few micrometers and a few millimeters.

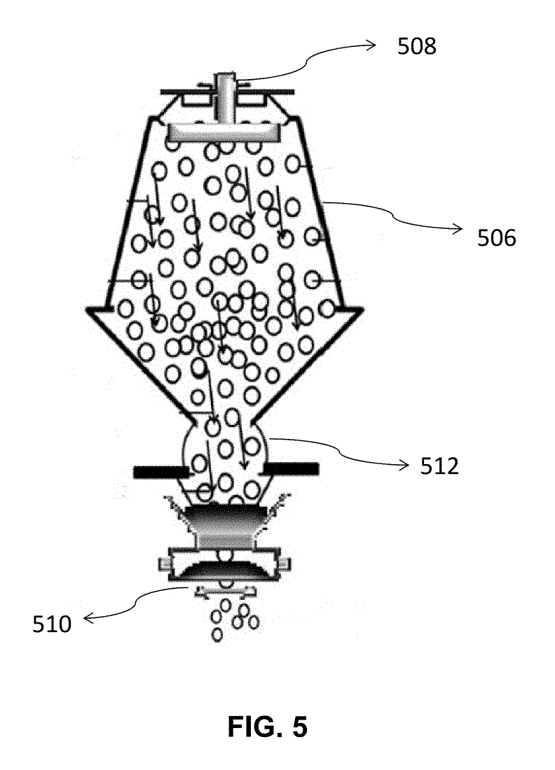

FIG. 5 illustrates complete spray drying method for microencapsulation. Further, the spray drying is performed by incorporating the micro spherules into a spray drying chamber via an input unit (508) provided at the top of the upper part of the spray drying chamber (506). Further, hot air is provided in the spray drying chamber in the same direction i.e. co-current flow as the sprayed liquid containing micro spherules, sea weed extract/gelatin, dextrin and water. Further, in the lower spray drying chamber (512) the materials are dried and all the moisture content now absorbed by hot air converting the hot air into cool air. Subsequently, spherules move downwards towards output unit (510), from where the encapsulated micro spherules are finally obtained. The encapsulated micro spherules, thus obtained from output unit (510) are completely free from liquid.

In accordance with an embodiment of the present invention, many microcapsules bear little resemblance to simple spheres. The core may be a crystal, a jagged adsorbent particle, an emulsion, a pickering emulsion, a suspension of solids, or a suspension of smaller microcapsules. The microcapsule even may have multiple walls.

In accordance with an embodiment of the present invention, microencapsulation can also be used to enclose solids, liquids, or gases inside a micrometric wall made of hard or soft soluble film, in order to reduce dosing frequency and prevent the degradation of pharmaceuticals. In a relatively simple form, a microcapsule is a small sphere with a uniform wall around it. Microcapsule is a hollow micro particle composed of a solid shell surrounding a core-forming space available to permanently or temporarily entrapped substances. The material inside the microcapsule is referred to as the core, internal phase, or fill, whereas the wall is sometimes called a shell, coating, or membrane.

In accordance with an embodiment of the present invention, encapsulation of the micro spherules (504) and bulking up is done using the material selected from the group consisting of, but not limited to, ethyl cellulose (EC), methylcellulose (MC), hypromellose (INN), hydroxypropyl cellulose (HPC), ethyl methylcellulose (EMC), soluble soybean polysaccharide (SSPS), or carbohydrates and combination thereof.

At step 140, adding a plurality of additives to the micro-encapsulated material to form the composition. Further, additives are selected from the group consisting of, but not limited to, sugars, carbonates, preservatives, oleoresins, flavors, emulsifiers, perfumes/aromatic materials, processed grains/fruits/juices/dry-fruits/nuts/spices, any other nutrients and cocktail mixes, may be added which are hermetically packed and sealed.

In accordance with an embodiment of the present invention, the sugars are selected from the group consisting of, but not limited to, monosaccharaides, disaccharides and natural and artificial sugar substitutes. Further, monosaccharides are selected from the group consisting of, but not limited to, fructose, galactose, and glucose. Further, disaccharides are selected from the group consisting of, but not limited to, lactose, maltose, and sucrose. Further, the sugar used can be natural/artificial sugar substitutes.

In accordance with an embodiment of the present invention, the carbonates are selected from the group consisting of, but not limited to, carbonate or bicarbonate salts. Further, these salts produce effervescence when dissolved in water.

In accordance with an embodiment of the present invention, the other nutrients are selected from the group consisting of, but not limited to, isotonic rehydration salts, electrolytes, antioxidants, minerals, vitamins, fiber.

In accordance with an embodiment of the present invention, the substance that are water soluble and/or form a colloidal suspension in water can be made available as a free-flowing powder or solid/semi-solid lumps, granules, cubes, pellets, tablets, bars, cakes, balls, or any other shape. Further, these are hermetically packed and sealed.

In accordance with an embodiment of the present invention, depending on the material that is used for micro encapsulation, the release of the potency of liquid based formulation may be adjusted, such that the release varies, e.g. ethyl cellulose will be a sustained release system and with other water-soluble materials, where the release will be relatively immediate.

In accordance with an embodiment of the present invention, the liquid based formulations or a composition of liquid based formulations in different consistencies and potency can also be made available in conventional capsules made from agar, alginates, carrageenan or gelatin. Further, it can be swallowed like any other capsules containing medication. The liquid based formulations or a composition of liquid based formulations may also be added to confectionery, ice creams, baked/cooked/fried/boiled/solid/liquid/semi solid edible, food items.

In accordance with an embodiment of the present invention, the liquid based formulations or a composition of liquid based formulations may be pre mixed in water and packed in glass bottles, plastic sachets; plastic/PET bottles; plastic/plastic-coated paper carton boxes or any synthetic or semi-synthetic organic compounds that are malleable and can be molded into solid objects/cases can be produced, and marketed.

In accordance with an embodiment of the present invention, ability to add the liquid based formulations or a composition of liquid based formulations of the present invention to reconstitute the alcohol at greater concentrations than intended can be dismissed due to the nature of chemistry and physics and the way this liquid based formulations or a composition of liquid based formulations is distributed in a solution. The concern for binge drinking or alcohol poisoning is greatly reduced than liquid alcohol.

In accordance with an embodiment of the present invention, potential to incorporate this bulked up substance, to snort it, is negligible as the amount needed is insurmountable for any single person, including unsupervised children, in a short enough time frame for any substantial effect, sever ingestion site or orifice pain if consumed in this form, or if mixed with medication sever intoxication but is not as great as with liquid based formulations.

It should also be understood that, unless specifically stated otherwise as apparent from the following discussion, it is appreciated that throughout the description, discussions utilizing terms such as “controlling” or “obtaining” or “computing” or “storing” or “receiving” or “determining” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices.

The terms and descriptions used herein are set forth by way of illustration only and are not meant as limitations. Examples and limitations disclosed herein are intended to be not limiting in any manner, and modifications may be made without departing from the spirit of the present disclosure. Those skilled in the art will recognize that many variations are possible within the spirit and scope of the disclosure, and their equivalents, in which all terms are to be understood in their broadest possible sense unless otherwise indicated.

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to be providing broadest scope of consistent with the principles and the novel and inventive features disclosed or suggested herein. Accordingly, the disclosure is anticipated to hold on to all other such alternatives, modifications, and variations that fall within the scope of the present disclosure and appended claims.

1. A composition with anti-snorting properties comprising:
a liquid based formulation;
a marine seaweed extract;
a plurality of salts; cellulose; carbohydrate and a plurality of additives.

2. The composition of claim 1, wherein the liquid based formulation is selected from the group consisting of, ethanol, edible spirits, juices, extracts and medicines containing water or alcohol.

3. The composition of claim 2, wherein the edible spirits are selected from the group consisting of, brandy, fruit brandies, ciders, fermented teas, wines, beers, horilkas, liqueurs, grain spirits, pisco, rice drinks, tequila, vodka, gin, rum, whisky, eau de vie, baijiu, soju, aguardiente, pálinka, cachaça, singani, borovička, slivovitz, fenny, arrack, toddy, sake, fermented spirits, Indian Made Foreign Liquor and ethanol.

4. The composition of claim 1, wherein the marine seaweed extract is selected from the group consisting of, agar, alginates, gelatin and carrageenan.

5. The composition of claim 1, wherein the plurality of salts are selected from the group comprising of, citrate, phosphate, chlorate, sulphate or acetate salts of potassium, sodium and calcium.

6. The composition of claim 1, wherein further plurality of additives are selected from the group consisting of, sugars, carbonates, preservatives, oleoresins, flavors, emulsifiers, aromatic materials, processed grains, fruits, juices, dry fruits, nuts, spices, nutrients, water soluble carbohydrates and combinations thereof.

7. The composition of claim 6, wherein the water-soluble carbohydrates are selected from the group consisting of, maltodextrin and cellulose.

8. The composition of claim 6, wherein the cellulose is selected from the group consisting of, ethylcellulose, methylcellulose, hypromellose, hydroxypropyl cellulose, ethyl-methylcellulose and soluble soybean polysaccharide.

9. The composition of claim 6, wherein the sugars are selected from the group consisting of, monosaccharaides, disaccharides and natural and artificial sugar substitutes.

10. The composition of claim 9, wherein the monosaccharaides are selected from the group consisting of, fructose, galactose and glucose.

11. The composition of claim 9, wherein the disaccharides are selected from the group consisting of, lactose, maltose and sucrose.

12. The composition of claim 6, wherein the carbonates are selected from the group consisting of, carbonate and bicarbonate salts.

13. The composition of claim 6, wherein the nutrients are selected from the group consisting of, isotonic rehydration salts, electrolytes, antioxidants, minerals, vitamins and fiber.

14. The composition of claim 6, wherein the oleoresins are selected from the group consisting of, pepper, chili and ginger.

15. The composition of claim 1, wherein the encapsulated the liquid based formulations are processed in different forms, selected from the group consisting of, free flowing powder, solid lumps, semi-solid lumps, granules, cubes, pellets, tablets, bars, cakes, balls and any other shapes.

16. A method for preparing a composition with anti-snorting properties, comprising the steps of:
polymerizing a liquid based formulation by spherification using a marine seaweed extract and a plurality of salts and cellulose, carbohydrate to form spherules that are dried;
pulverizing the spherules to form micro-spherules;
micro-encapsulating the micro-spherules; and
adding a plurality of additives to the micro-encapsulated spherules.

17. The method of claim 16, wherein the liquid based formulation is selected from the group consisting of, edible spirits, juices, extracts and medicines containing water or alcohol.

18. The method of claim 17, wherein the edible spirits are selected from the group consisting of, brandy, fruit brandies, ciders, fermented teas, wines, beers, horilkas, liqueurs, grain spirits, pisco, rice drinks, tequila, vodka, gin, rum, whisky, eau de vie, baijiu, soju, aguardiente, pálinka, cachaça, singani, borovička, slivovitz, fenny, arrack, toddy, sake and fermented spirits, Indian Made Foreign Liquor and ethanol.

19. The method of claim 16, wherein the marine seaweed extract is selected from the group consisting of, agar, alginates, gelatin and carrageenan.

20. The method of claim 16, wherein the plurality of salts are selected from the group comprising of, citrate, phosphate, chlorate, sulphate or acetate salts of potassium, sodium and calcium.

21. The method of claim 16, wherein further plurality of additives are selected from the group consisting of, sugars, carbonates, preservatives, oleoresins, flavors, emulsifiers, aromatic materials, processed grains, fruits, juices, dry fruits, nuts, spices, nutrients, water soluble carbohydrates and combinations thereof.

22. The method of claim 21, wherein the water-soluble carbohydrates are selected from the group consisting of, maltodextrin and cellulose.

23. The method of claim 21, wherein the cellulose are selected from the group consisting of, ethylcellulose, methylcellulose, hypromellose, hydroxypropyl cellulose, ethyl-methylcellulose and soluble soybean polysaccharide.

24. The method of claim 21, wherein the sugars are selected from the group consisting of, monosaccharaides, disaccharides and natural and artificial sugar substitutes.

25. he method of claim 24, wherein the monosaccharaides are selected from the group consisting of, fructose, galactose and glucose.

26. The method of claim 24, wherein the disaccharides are selected from the group consisting of, lactose, maltose and sucrose.

27. The method of claim 21, wherein the carbonates are selected from the group consisting of, carbonate and bicarbonate salts.

28. The method of claim 21, wherein the nutrients are selected from the group consisting of, isotonic rehydration salts, electrolytes, antioxidants, minerals, vitamins and fiber.

29. The method of claim 21, wherein the oleoresins are selected from the group consisting of, pepper, chili and ginger.
